(19) United States
(12) Patent Application Publication
(10) Pub. No.: US 2020/0370993 A1
(43) Pub. Date: Nov. 26, 2020

(54) LEAK DETECTION DEVICE AND LEAK DETECTION METHOD

(71) Applicant: Ping-Tsun WU, Zhubei City (TW)

(72) Inventor: Ping-Tsun WU, Zhubei City (TW)

(21) Appl. No.: 16/878,247

(22) Filed: May 19, 2020

(30) Foreign Application Priority Data
May 21, 2019 (TW) 108117562

(51) Int. Cl. G01M 3/32; G01M 3/34

(52) U.S. Cl. CPC G01M 3/3236; G01M 3/34

(57) ABSTRACT

A leak detection device for detecting leakage of a chamber includes a leak detection assembly, a first isolation valve, a suction pump and a second isolation valve. The leak detection assembly includes a gas sensor for detecting a first specified gas in the chamber. The first isolation valve is coupled between the chamber and the leak detection assembly to selectively permit and prevent fluid communication between the chamber and the leak detection assembly. The suction pump draws out air in the chamber to allow a pressure inside the chamber to be lower than a pressure outside the chamber. The second isolation valve is coupled between the chamber and the suction pump to selectively permit and prevent fluid communication between the chamber and the suction pump.

### BACKGROUND OF THE INVENTION

### a. Field of the Invention

The invention relates to a leak detection device and a leak detection method.

### b. Description of the Related Art

In various industries, creating an airtight seal for an apparatus or a device is often needed. For example, some semiconductor fabrication processes, such as physical-vapor-deposition or chemical-vapor-deposition processes, are carried out in a vacuum or low-pressure chamber. Also, a filter of a water purifier or a water tank of a car must ensure that it does not leak during use. Therefore, the apparatus/device is often subject to leak detection before leaving the factory or following a routine maintenance schedule.

A typical leak detection method relying on measuring the amount of pressure rise inside a test object is liable to be affected by gas liberation on the inside wall of the test object (i.e., outgassing), which may result in poor detection accuracy and long test time. Therefore, it is desirable to improve the conventional leak detection method to resolve the above problems.

### BRIEF SUMMARY OF THE INVENTION

According to one aspect of the present disclosure, a leak detection device for detecting leakage of a chamber includes a leak detection assembly, a first isolation valve, a suction pump and a second isolation valve. The leak detection assembly includes a gas sensor for detecting a first specified gas in the chamber. The first isolation valve is coupled between the chamber and the leak detection assembly to selectively permit and prevent fluid communication between the chamber and the leak detection assembly. The suction pump draws out air in the chamber to allow a pressure inside the chamber to be lower than a pressure outside the chamber. The second isolation valve is coupled between the chamber and the suction pump to selectively permit and prevent fluid communication between the chamber and the suction pump.

According to another aspect of the present disclosure, a leak detection device for detecting leakage of at least one object includes a chamber, a connection device, a leak detection assembly, a first isolation valve, a suction pump and a second isolation valve. The connection device connects the at least one object to the chamber. The leak detection assembly includes a gas sensor for detecting a first specified gas in the chamber. The first isolation valve is coupled between the chamber and the leak detection assembly to selectively permit and prevent fluid communication between the chamber and the leak detection assembly. The suction pump draws out air in the chamber to allow a pressure inside the chamber to be lower than a pressure outside the chamber. The second isolation valve is coupled between the chamber and the suction pump to selectively permit and prevent fluid communication between the chamber and the suction pump.

According to another aspect of the present disclosure, a leak detection method including the steps of: drawing out air including a first specified gas in a chamber to allow a pressure inside the chamber to be lower than a pressure outside the chamber, measuring a partial pressure of the first specified gas in the chamber at different time points of a prescribe time period to obtain a leak rate of the first specified gas, and estimating an overall leak rate according to the leak rate of the first specified gas and a relative percentage of the first specified gas in the air.

According to the above aspects, more accurate leak detection results can be achieved because the leak detection process described in the above embodiments is not affected by outgassing. Therefore, the leak detection device according to the above embodiments can detect a very small leak rate up to about 10\hat{ }−7 mbar·1/s, and can perform leak detection at a pressure higher than the base pressure. Moreover, the leak detection device may achieve low fabrication costs and self-calibration and does not use consumable materials.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows a leak detection device according to a first embodiment of the invention.

FIG. 2 shows a flow chart diagram illustrating a leak detection method for the leak detection device shown in FIG. 1.

FIG. 3 illustrates measurement results of the first embodiment where a leak of the chamber exists.

FIG. 4 shows a schematic diagram illustrating a leak detection device according to a second embodiment of the invention.

FIG. 5 shows a flow chart diagram illustrating a leak detection method for the leak detection device shown in FIG. 4.

FIG. 6 shows a schematic diagram illustrating a leak detection device according to a third embodiment of the invention.

FIG. 7 shows a flow chart diagram illustrating a leak detection method for the leak detection device shown in FIG. 6.

FIG. 8 shows a schematic diagram illustrating a leak detection device according to a fourth embodiment of the invention.

FIG. 9 illustrates measurement results of the fourth embodiment where a leak of the chamber exists.

FIG. 10 shows a schematic diagram illustrating a leak detection device according to a fifth embodiment of the invention.

FIG. 11 shows a flow chart diagram illustrating a leak detection method for the leak detection device shown in FIG. 10.

FIG. 12 shows a schematic diagram illustrating a leak detection device according to a sixth embodiment of the invention.

FIG. 13 shows a flow chart diagram illustrating a leak detection method for the leak detection device shown in FIG. 12.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Embodiments of the present disclosure are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

Further, spatially relative terms, such as “beneath,” “below,” “lower,” “above,” “upper”, “lower”, “left”, “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. It will be understood that when an element is referred to as being “connected to” or “coupled to” another element, it may be directly connected to or coupled to the other element, or intervening elements may be present.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Typical leak detection methods may include, for example, helium leak detection, hydrogen leak detection and pressure rise test.

Helium leak detection relies on a helium leak detector and helium as a working fluid to perform leak detection on an object/device/apparatus to be tested (hereinafter referred to as a “test object”). Helium has very small mass (second only to hydrogen) and has the ability to penetrate into tiny gaps. After helium is injected into the test object, if the test object has a crack, the helium leaks out and is detected by the helium leak detector outside the test object, and then a leak rate can be estimated by the helium leak detector. However, because the price of helium continues to rise and the helium leak detector is very expensive, using the helium leak detection method may cause considerable costs. The helium leak detection method may achieve a leak detection sensitivity up to 10\hat{ }−12 mbar·1/s.

Hydrogen leak detection relies on a hydrogen leak detector to perform leak detection on a test object. Hydrogen is a highly flammable substance. As long as the volume ratio of hydrogen in the air is between 4% and 75%, it can be burned. Therefore, the working fluid used for hydrogen leak detection is a gas mixture of 5% hydrogen and 95% nitrogen. Similar to the Helium leak detection method, when hydrogen gas mixture is injected into the test object, if the test object has a crack, the hydrogen gas mixture leaks out and is detected by the hydrogen leak detector outside the test object, and then a leak rate can be estimated by the hydrogen leak detector. The hydrogen leak detection method is often applied to leak detection for automobile parts or refrigeration air conditioners. A positive-pressure hydrogen leak detection method may achieve a leak detection sensitivity up to 10\hat{ }−6 mbar·1/s.

The pressure rise test is used only to measure an overall leak rate of a test object. First, a suction pump or a pumping system evacuates the test object to achieve a base pressure condition inside the test object. The overall leak rate is estimated by measuring the rise in pressure during a prescribed time (pressure rise as a function of time). The pressure rise test has a main disadvantage that the measurement is often affected by gas liberation or liquid evaporation on the inside wall of the test object (i.e., outgassing) to reduce the leak detection sensitivity/accuracy, because outgassing effects may increase internal pressure and cause an misinterpretation of the curve depicting the rise in pressure as a function of time. The detectable range of leak rate of the pressure rise test depends on the volume of the test object, the limit of the base pressure, and the gas release rate of the test object. The pressure rise test may achieve a leak detection sensitivity up to 10\hat{ }−3 mbar·1/s.

In the present disclosure, a base pressure is defined as a pressure far below atmospheric pressure and obtained by using a suction pump or another air pumping system. The vacuum leakage is defined as a leakage where a gas outside a test object under the base pressure condition penetrates into the test object through a crack or hole on the test object. The vacuum leakage may occur as a result of materials of various parts of the test product and fabrication processes, and the gas may penetrate through tiny holes, splits, weld cracks, etc. The leak detection method according to various embodiments of the invention is directed to measuring a partial pressure of an external specified gas that penetrates into the inside of a test object. The leak detection method is described in detail below.

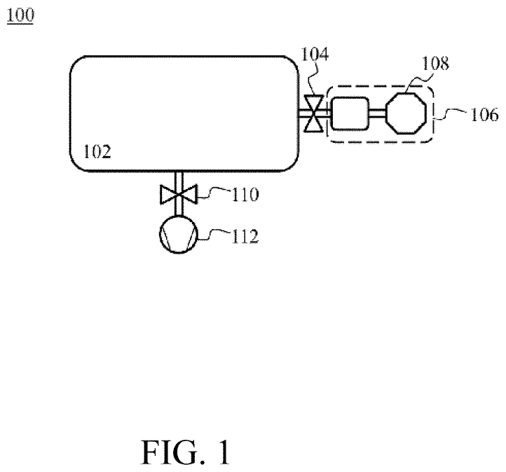

FIG. 1 shows a leak detection device according to a first embodiment of the invention. A leak detection device 10 may include a chamber 102 serving as a test object in this embodiment. The chamber 102 is not limited to a specific material and a specific application environment. A first isolation valve 104 and a second isolation valve 110 are coupled to an outer wall of the chamber 102. During operation, the space outside the chamber 102 is a typical ambient air environment but not supplied with any specified gas. The first isolation valve 104 selectively permits and prevents fluid communication between the chamber 102 and the leak detection assembly 106. The second isolation valve 110 selectively permits and prevents fluid communication between the chamber 102 and the suction pump 112. The suction pump 112 may be, for example, a vacuum pump. The leak detection assembly 106 may include a gas sensor 108 for measuring a partial pressure of a first specified gas in the chamber 102. The gas sensor 108 may be a mass spectroscope (such as a quadrupole mass spectroscope) or an optical emission spectrometer. In this embodiment, the first specified gas is oxygen, and the gas sensor 108 for detecting oxygen is advantageous as being inexpensive. However, except for oxygen, the gas sensor 108 may detect, without restriction, other gases such as nitrogen and argon. In this embodiment, the possible leak of the chamber 102 is detected by the gas sensor 108 of the leak detection assembly 106 and the suction pump 112.

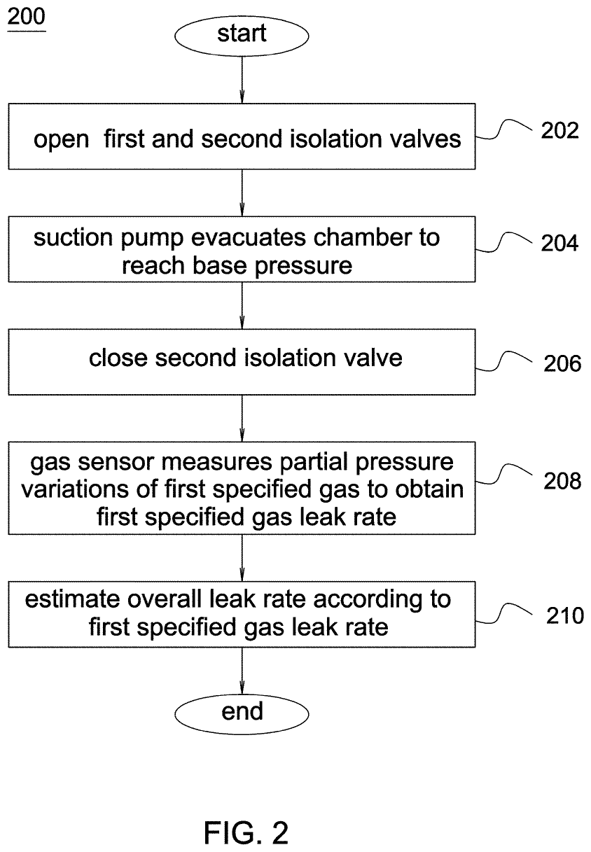

FIG. 2 shows a flow chart diagram 200 illustrating a leak detection method for the leak detection device 100 shown in FIG. 1. Please refer to both FIG. 1 and FIG. 2, first, the first isolation valve 104 and the second isolation valve 110 are opened to permit fluid communication among the chamber 102, the leak detection assembly 106 and the suction pump 112 (Step 202). In case the chamber 102 does not have any leak, the chamber 102, the leak detection assembly 106 and the suction pump 112 altogether form a sealed environment. Then, the suction pump 112 evacuates the chamber 102 till the chamber 102 reaches a base pressure condition (Step 204), and then the second isolation valve 110 between the chamber 102 and the suction pump 112 is closed (Step 206). At this time, even no leak exists, a tiny amount of liquid on the inner wall may vaporize to become gas, called outgassing, to gradually increase the pressure inside the chamber 102 to reach a value higher than the base pressure. The gas sensor 108 of the leak detection assembly 106 measures partial pressure values of the first specified gas in the chamber 102 at different time points of a prescribe time period to obtain a variation curve of the partial pressure of the first specified gas and therefore obtain a leak rate of the first specified gas (Step 208). For example, in case the first specified gas is oxygen, an oxygen sensor is used to measure the partial pressure of oxygen in the chamber 102 at different time points of a prescribe time period(such as two minutes) to detect variations of the partial pressure of oxygen over time to obtain a leak rate of oxygen. Once the leak rate of the first specified gas is obtained, the overall leak rate of the chamber 102 (the leak rate of air including the first specified gas) can be estimated according to the leak rate of the first specified gas and the relative percentage of the first specified gas in the air (Step 210).

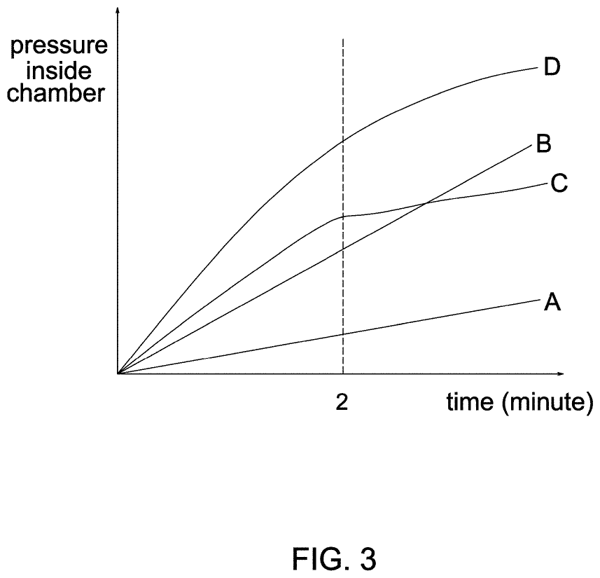

FIG. 3 illustrates measurement results of the first embodiment where a leak of the chamber 102 exists. In FIG. 3, Curve A shows variations over time of the oxygen partial pressure in the chamber 102 measured by the oxygen sensor 108, Curve B shows variations over time of the air partial pressure in the chamber 102, where the air partial pressure is contributed by air (such as including nitrogen, oxygen and argon) penetrating into the chamber 102 through a crack. Curve C shows variations over time of the outgas partial pressure in the chamber 102, where the outgas partial pressure is contributed by gas liberation on the inside wall of the chamber, i.e., outgassing phenomenon. Curve D shows variations over time of the overall pressure in the chamber 102, where the variations of the overall pressure is contributed by the air penetrating into the chamber 102 (air leakage) and gas liberation on the inside wall of the chamber 102 (outgassing). As shown in FIG. 3, Curve A representing the oxygen partial pressure in the chamber 102 and Curve B representing the air partial pressure in the chamber 102 are both straight lines with linear increment and have a proportional relationship (i.e., the percentage of oxygen in the air). In other words, the oxygen leak rate detected by the oxygen sensor 108 can be divided by the percentage of oxygen in the air to obtain the actual overall leak rate of the chamber 102 (air leak rate in this embodiment).

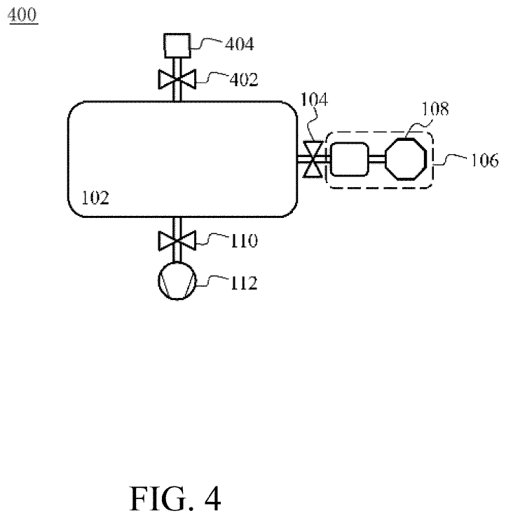

FIG. 4 shows a schematic diagram illustrating a leak detection device according to a second embodiment of the invention. The leak detection device 400 in FIG. 4 is similar to the leak detection device 100 in FIG. 1, except that the leak detection device 400 in FIG. 4 further includes a third isolation valve 402 coupled between the chamber 102 and a gas supply 404. The third isolation valve 402 selectively permits or prevents fluid communication between the chamber 102 and a gas supply 404. The gas supply 404 supplies a second specified gas different to the first specified gas. For example, the second specified gas may be nitrogen or argon, and the first specified gas may be oxygen. The leak detection device 400 can be used to detect the leakage of a chemical-vapor-deposition chamber. In a chemical-vapor-deposition process, the chamber needs to be filled with nitrogen or argon to avoid oxidation. Compared with a convention leak detection process where nitrogen or argon inside the chamber needs to be drawn out to form a vacuum environment, the leak detection device 400 realizes leak detection without the need of a vacuum environment. The details of the leak detection device 400 are described below.

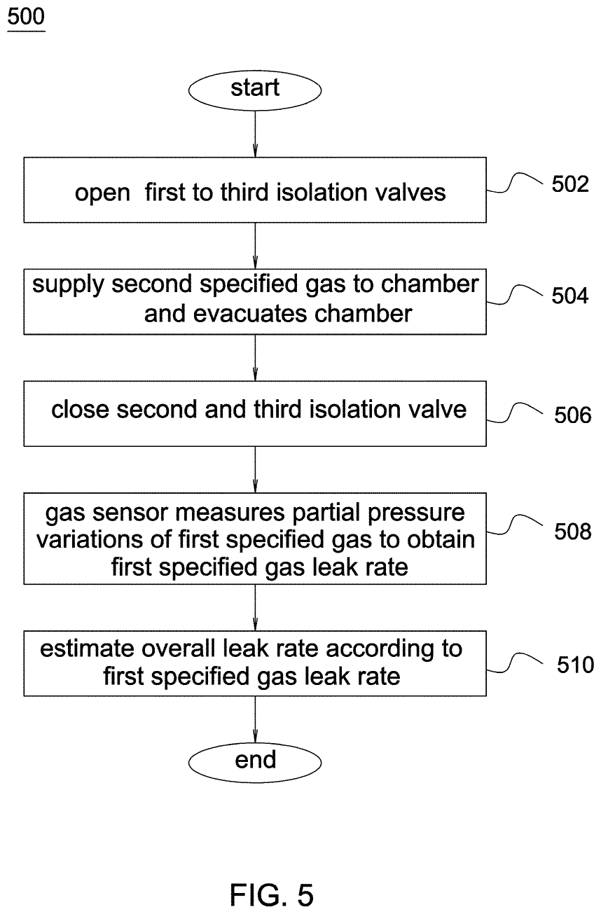

FIG. 5 shows a flow chart diagram 500 illustrating a leak detection method for the leak detection device 400 shown in FIG. 4. Please refer to both FIG. 4 and FIG. 5, first, the first isolation valve 104, the second isolation valve 110 and third isolation valve 402 are opened to permit fluid communication among the chamber 102, the leak detection assembly 106, the suction pump 112 and gas supply 404 (Step 502). In case the chamber 102 does not have any leak, the chamber 102, the leak detection assembly 106, the suction pump 112 and the gas supply 404 altogether form a sealed environment. Then, the gas supply 404 continually supplies the chamber 102 with the second specified gas, and meanwhile the suction pump 112 evacuates the chamber 102 (Step 504). Because the gas supply 404 continually supplies the chamber 102 with a second specified gas, the chamber 102 may maintain a prescribed pressure high than the base pressure but not the base pressure. Thereafter, the second isolation valve 110 between the chamber 102 and the suction pump 112 and the third isolation valve 402 between the chamber 102 and the gas supply 404 are closed (Step 506). At this time, even no leak exists, a tiny amount of liquid such as water on the inner wall may vaporize to become gas to thus gradually increase the pressure inside the chamber 102 to reach a value higher than the prescribed pressure. The gas sensor 108 of the leak detection assembly 106 measures the partial pressure values of the first specified gas in the chamber 102 at different time points of a prescribe time period to obtain a variation curve of the partial pressure of the first specified gas and therefore obtain a leak rate of the first specified gas (Step 508). Therefore, similar to the Step 210, the overall leak rate of the chamber 102 can be estimated according to the leak rate of the first specified gas and the relative percentage of the first specified gas in the air (Step 510).

According to the above embodiment, Step 504 is originally a necessary step for certain process such as a chemical-vapor-deposition process but not a step particularly for leak detection purposes; therefore, the leak detection method shown in FIG. 5 that does not need to create a base pressure condition can be integrated into the chemical-vapor-deposition process. Similarly, the fundamental principle for the leak detection method shown in FIG. 5 is to measure the partial pressure variations of the first specified gas, which is not affected by outgassing. Therefore, even the chamber 102 having been evacuated does not reach the base pressure, the partial pressure variations of the first specified gas can be still accurately and quickly detected.

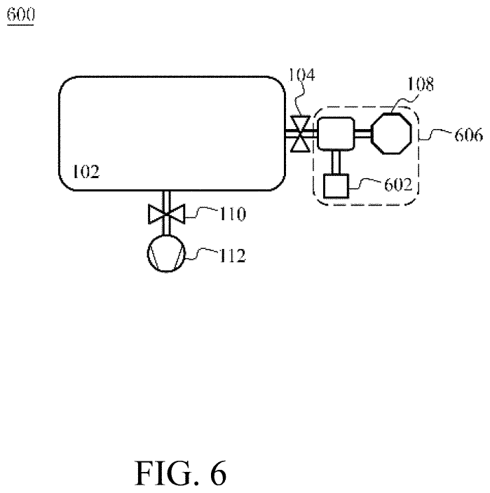

FIG. 6 shows a schematic diagram illustrating a leak detection device according to a third embodiment of the invention. The leak detection device 500 in FIG. 4 is similar to the leak detection device 100 in FIG. 1, except that the leak detection assembly 606 in FIG. 6 further includes a calibrated leak element 602 for controlling the amount of outside air penetrating into the chamber 102. The calibrated leak element 602 is controlled to provide a prescribed amount of leak air and may be, for example, a standard leak for sensor calibration or a calibrated leak valve. In this embodiment, the calibrated leak element 602 is used to generate a prescribed leak rate. The measurement accuracy of the gas sensor 108 can be evaluated by comparing the prescribed leak rate and the leak rate obtained by the gas sensor 108.

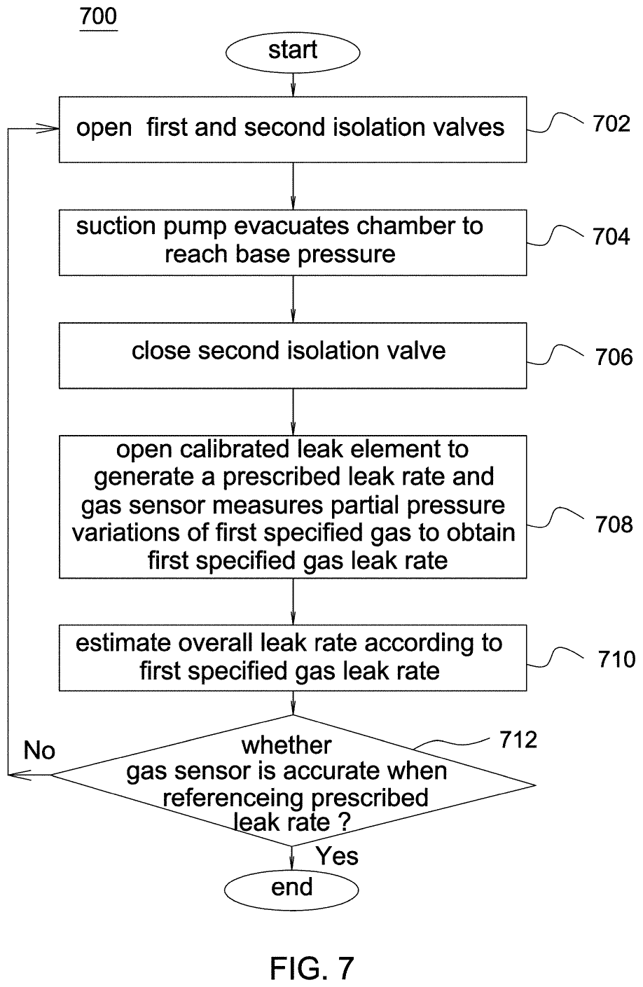

FIG. 7 shows a flow chart diagram 600 illustrating a leak detection method for the leak detection device 600 shown in FIG. 6. Please refer to both FIG. 6 and FIG. 7, first, the first isolation valve 104 and the second isolation valve 110 are opened to permit fluid communication among the chamber 102, the leak detection assembly 606 and the suction pump 112 (Step 702). In case the chamber 102 does not have any leak, the chamber 102, the leak detection assembly 606 and the suction pump 112 altogether form a sealed environment. Then, the suction pump 112 evacuates the chamber 102 till the chamber 102 reaches a base pressure condition (Step 704), and then the second isolation valve 110 between the chamber 102 and the suction pump 112 are closed (Step 706). At this time, even no leak exists, a tiny amount of liquid (such as water) on the inner wall of the chamber 102 may vaporize to become gas, called outgassing, to gradually increase the pressure inside the chamber 102 to reach a value higher than the base pressure. Then, the calibrated leak element 602 is opened to allow air (including the first specified gas) outside the chamber 102 to penetrate into the chamber 102 through the calibrated leak element and thus generate a prescribed leak rate. The gas sensor 108 of the leak detection assembly 106 measures the partial pressure values of the first specified gas in the chamber 102 at different time points of a prescribe time period to obtain a variation curve of the partial pressure of the first specified gas and therefore obtain a leak rate of the first specified gas (Step 708). Therefore, the overall leak rate of the chamber 102 can be estimated according to the leak rate of the first specified gas and the relative percentage of the first specified gas in the air (Step 710). Finally, the estimated overall leak rate of the chamber 102 is compared with the prescribed leak rate of the calibrated leak element 602 to judge whether the measurement of the gas sensor 108 is accurate (Step 712). For example, in case the difference of the two leak rate values is more than 20%, the measurement of the gas sensor 108 is considered inaccurate and the steps 702-712 need to be repeatedly preformed until the difference of two leak rate values is no more than 20%.

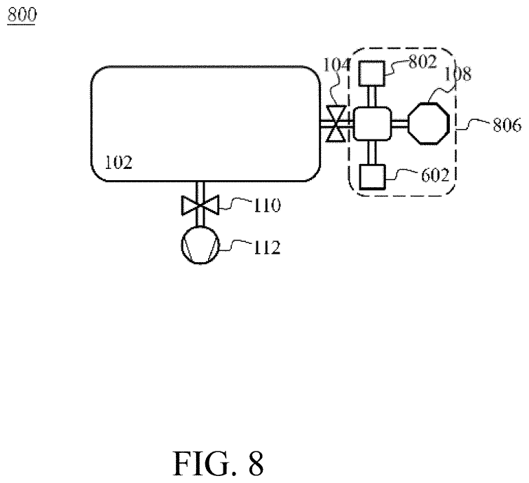

FIG. 8 shows a schematic diagram illustrating a leak detection device according to a fourth embodiment of the invention. The leak detection device 800 in FIG. 8 is similar to the leak detection device 600 in FIG. 6, except that the leak detection assembly 806 in FIG. 8 further includes a vacuum gauge 802. The vacuum gauge 802 is used to measure the internal pressure of the chamber 102. By comparing the internal pressure measured by the vacuum gauge 802 with the pressure variations of the first specified gas measured by the gas sensor 108, the degree of outgassing inside the chamber 102 can be identified.

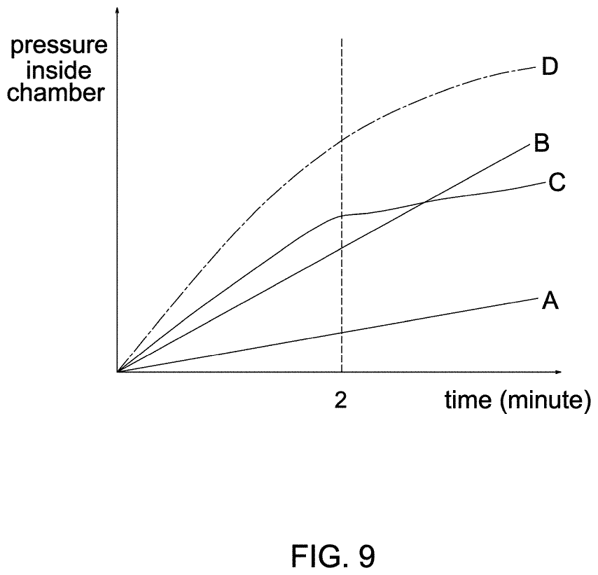

FIG. 9 illustrates measurement results of the fourth embodiment where a leak of the chamber exists. FIG. 9 depicts four curves and is different to FIG. 3 in that Curve D represents the internal pressure of the chamber 102 measured by the vacuum gauge 802. The Curves A, B and C in FIG. 9 represent the same parameters as in FIG. 3. As shown in FIG. 9, Curve A representing the oxygen partial pressure in the chamber 102 and Curve B representing the air partial pressure in the chamber 102 are both straight lines with linear increment and have a proportional relationship (i.e., the percentage of oxygen in the air). In other words, the oxygen leak rate detected by the oxygen sensor 108 can be divided by the percentage of oxygen in the air to calculate the actual overall leak rate of the chamber 102. Further, Curve D of FIG. 9 indicates the internal pressure of the chamber 102 measured by the vacuum gauge 802 is affected by outgassing at the beginning of the detection process for about two minutes (outgassing phenomenon lasting about two minutes and then fading away). Therefore, it shows the leak rate evaluated according to the gauge pressure may larger than actual leak rate of the chamber 102. That is, if the waiting period is not long enough, one may misinterprets the outgassing phenomenon as the leakage of the clamber 102.

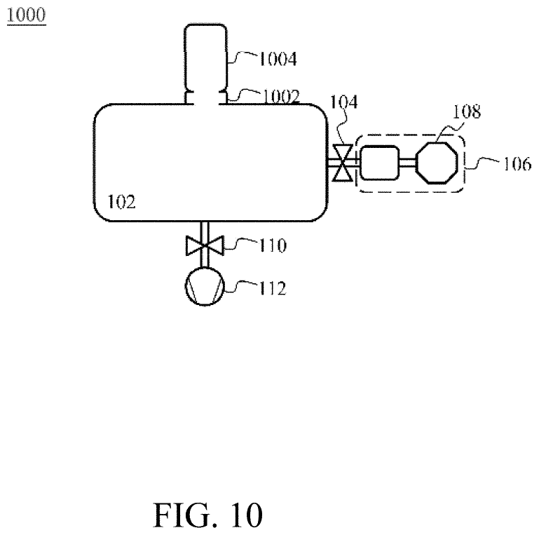

FIG. 10 shows a schematic diagram illustrating a leak detection device according to a fifth embodiment of the invention. The leak detection device 1000 in FIG. 10 is similar to the leak detection device 100 in FIG. 1, except that the leak detection device 1000 in FIG. 10 further includes an external object 1004 to be tested. The external object 1004, serving as a test object, is disposed on an outer wall of the chamber 102 via a connection device 1002. The external test object 1004 is not limited to a specific material or application environment. Once an airtight seal of the chamber 102 is confirmed, the leak detection device 1000 FIG.10 can be used to examine whether the external test object 1004 has a leak. The details of this leak detection method are described below. Note the leak detection method can perform leak detection on multiple external test objects 1004 at once.

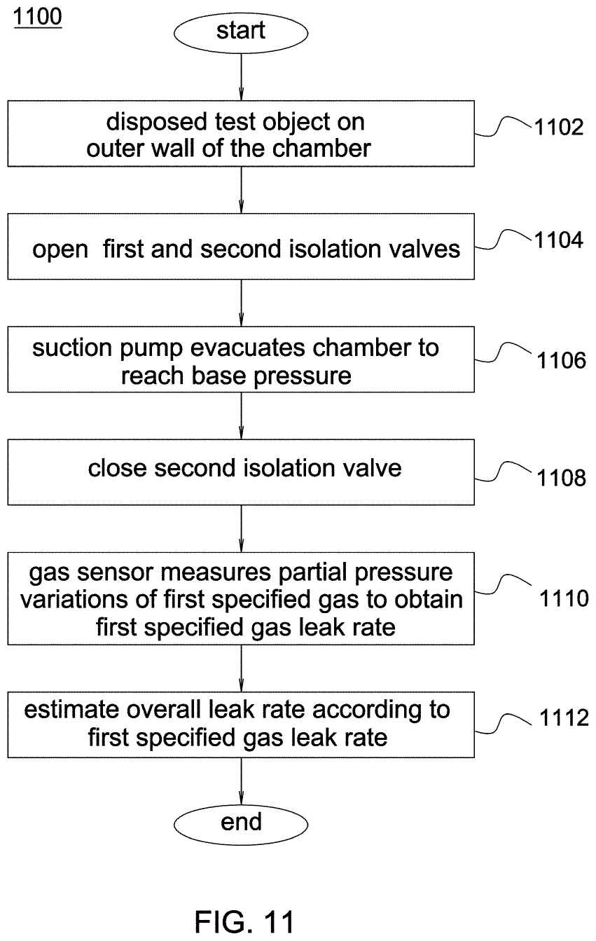

FIG. 11 shows a flow chart diagram 1100 illustrating a leak detection method for the leak detection device 1000 shown in FIG. 10. Please refer to both FIG. 10 and FIG. 11, first, at least one test object 1004 is disposed on an outer wall of the chamber 102 via a connection device 1002 to permit fluid communication between the inside space of the test object 1004 and the inside space of the chamber 102 (Step 1102). Then, the first isolation valve 104 and the second isolation valve 110 are opened to permit fluid communication between the chamber 102, the leak detection assembly 106, the test object 1004 and the suction pump 112 (Step 1104). In case the test object 1004 does not have any leak, the chamber 102, the leak detection assembly 106, the test object 1004 and the suction pump 112 altogether form a sealed environment. Then, the suction pump 112 evacuates the chamber 102 till the chamber 102 reaches a base pressure condition (Step 1106), and then the second isolation valve 110 between the chamber 102 and the suction pump 112 are closed (Step 1108). At this time, even no leak exists, a tiny amount of liquid (such as water) on the inner wall of the chamber 102 and the inner wall of the test object 1004 may vaporize to become gas, called outgassing, to gradually increase the pressure inside the chamber 102 and the test object 1004 to reach a value higher than the base pressure. The gas sensor 108 of the leak detection assembly 106 measures the partial pressure values of the first specified gas in the chamber 102 and the test object 1004 at different time points of a prescribe time period to obtain a variation curve of the partial pressure of the first specified gas, and therefore obtain a leak rate of the first specified gas (Step 1110). For example, in case the first specified gas is oxygen, an oxygen sensor is used to measure the partial pressure of oxygen in the chamber 102 and the test object 1004 at different time points of a prescribe time period (such as two minutes) to detect variations of the partial pressure of oxygen over time to obtain a leak rate of oxygen. Therefore, the overall leak rate of the test object 1004 can be estimated according to the leak rate of the first specified gas and the relative percentage of the first specified gas in the air (Step 1112).

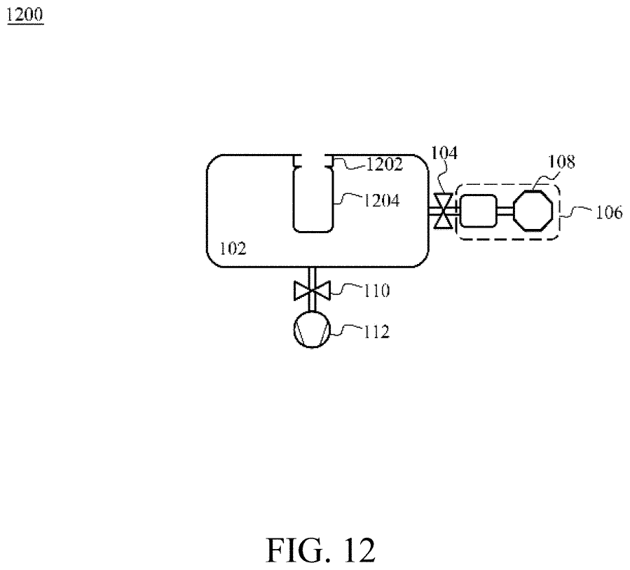

FIG. 12 shows a schematic diagram illustrating a leak detection device according to a sixth embodiment of the invention. The leak detection device 1200 in FIG. 12 is similar to the leak detection device 1000 in FIG. 10, except that a test object 1204 in FIG. 12 is disposed on an inner wall of the chamber 102 via a connection device 1202. The test object 1204 is not limited to a specific material or application environment. Once an air-tight seal of the chamber 102 is confirmed, the leak detection device 1200 in FIG. 12 can be used to examine whether the test object 1204 has a leak. The details of this leak detection method are described below. Note the leak detection method can perform leak detection on multiple test objects 1204 disposed inside the chamber 102 at once.

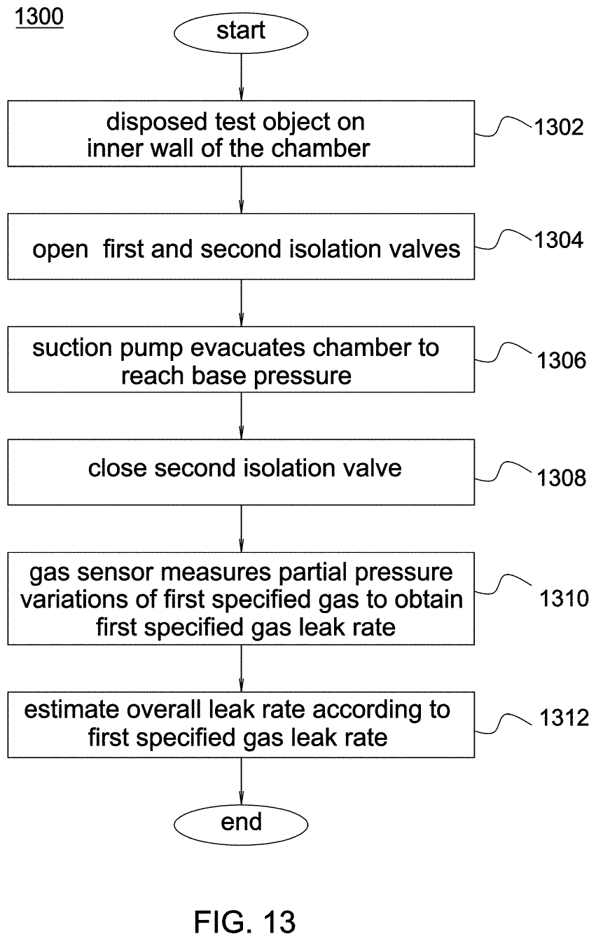

FIG. 13 shows a flow chart diagram 1300 illustrating a leak detection method for the leak detection device 1000 shown in FIG. 12. Please refer to both FIG. 12 and FIG. 13, first, at least one test object 1204 is disposed on an inner wall of the chamber 102 via a connection device 1202 to permit fluid communication between the inside space of the test object 1204 and the outside of the chamber 102 (Step 1302). Then, the first isolation valve 104 and the second isolation valve 110 are opened (Step 1304). Then, the suction pump 112 evacuates the chamber 102 till the chamber 102 reaches a base pressure condition (Step 1306), and then the second isolation valve 110 between the chamber 102 and the suction pump 112 are closed (Step 1308). At this time, even no leak exists, a tiny amount of liquid (such as water) on the inner wall of the chamber 102 and the outer wall of the test object 1204 may vaporize to become gas, called outgassing, to gradually increase the pressure inside the chamber 102 to reach a value higher than the base pressure. The gas sensor 108 of the leak detection assembly 106 measures the partial pressure values of the first specified gas in the chamber 102 at different time points of a prescribe time period to obtain a variation curve of the partial pressure of the first specified gas, and therefore obtain a leak rate of the first specified gas (Step 1310). For example, in case the first specified gas is oxygen, an oxygen sensor is used to measure the partial pressure of oxygen in the chamber 102 at different time points of a prescribe time period(such as two minutes) to detect variations of the partial pressure of oxygen over time to obtain a leak rate of oxygen. Therefore, the overall leak rate of test object 1204 can be estimated according to the leak rate of the first specified gas and the relative percentage of the first specified gas in the air (Step 1312).

According to the above embodiments, more accurate leak detection results can be achieved because the leak detection process described in the above embodiments is not affected by outgassing. Therefore, the leak detection device according to the above embodiments can detect a very small leak rate up to about 10\hat{ }−7 mbar·1/s, and can perform leak detection at a pressure higher than the base pressure. Moreover, the leak detection device may achieve low fabrication costs and self-calibration and does not use consumable materials.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A leak detection device for detecting leakage of a chamber, the leak detection device comprising:
a leak detection assembly including a gas sensor for detecting a first specified gas in the chamber;
a first isolation valve coupled between the chamber and the leak detection assembly to selectively permit and prevent fluid communication between the chamber and the leak detection assembly;
a suction pump for drawing out air in the chamber to allow a pressure inside the chamber to be lower than a pressure outside the chamber; and
a second isolation valve coupled between the chamber and the suction pump to selectively permit and prevent fluid communication between the chamber and the suction pump.

2. The leak detection device as claimed in claim 1, wherein the first specified gas is oxygen.

3. The leak detection device as claimed in claim 1, wherein the gas sensor detects a partial pressure of the first specified gas in the chamber.

4. The leak detection device as claimed in claim 3, wherein the gas sensor includes a mass spectroscope or an optical emission spectrometer.

5. The leak detection device as claimed in claim 1, further comprising:
a gas supply for supplying the chamber with a second specified gas; and
a third isolation valve coupled between the chamber and the gas supply to selectively permits or prevents fluid communication between the chamber and the gas supply.

6. The leak detection device as claimed in claim 1, wherein the leak detection assembly further comprises:
a calibrated leak element for controlling an amount of air penetrating into the chamber from an outside of the chamber to provide a prescribed leak rate.

7. The leak detection device as claimed in claim 6, wherein the calibrated leak element is a calibrated leak valve or a standard leak for sensor calibration.

8. The leak detection device as claimed in claim 1, wherein the leak detection assembly further comprises:
a vacuum gauge for measuring an internal pressure of the chamber.

9. The leak detection device as claimed in claim 1, wherein the chamber is evacuated to reach a pressure value equal to a base pressure or higher than the base pressure.

10. A leak detection device for detecting leakage of at least one object, the leak detection device comprising:
a chamber;
a connection device for connecting the at least one object to the chamber;
a leak detection assembly including a gas sensor for detecting a first specified gas in the chamber;
a first isolation valve coupled between the chamber and the leak detection assembly to selectively permit and prevent fluid communication between the chamber and the leak detection assembly;
a suction pump for drawing out air in the chamber to allow a pressure inside the chamber to be lower than a pressure outside the chamber; and
a second isolation valve coupled between the chamber and the suction pump to selectively permit and prevent fluid communication between the chamber and the suction pump.

11. The leak detection device as claimed in claim 10, wherein the at least one object is disposed on an outer wall of the chamber, and an inside space of the at least one object is in fluid communication with an inside space of the chamber.

12. The leak detection device as claimed in claim 10, wherein the at least one object is disposed on an inner wall of the chamber, and an inside space of the at least one object is in fluid communication with an outside of the chamber.

13. The leak detection device as claimed in claim 10, further comprising:
a gas supply for supplying the chamber with a second specified gas; and
a third isolation valve coupled between the chamber and the gas supply to selectively permits or prevents fluid communication between the chamber and the gas supply.

14. The leak detection device as claimed in claim 10, wherein the leak detection assembly further comprises:
a calibrated leak element for controlling an amount of air penetrating into the chamber from an outside of the chamber to provide a prescribed leak rate.

15. The leak detection device as claimed in claim 14, wherein the calibrated leak element is a calibrated leak valve or a standard leak for sensor calibration.

16. The leak detection device as claimed in claim 10, wherein the leak detection assembly further comprises:
a vacuum gauge for measuring an internal pressure of the chamber.

17. A leak detection method, comprising:
drawing out air including a first specified gas in a chamber to allow a pressure inside the chamber to be lower than a pressure outside the chamber;
measuring a partial pressure of the first specified gas in the chamber at different time points of a prescribe time period to obtain a leak rate of the first specified gas; and
estimating an overall leak rate according to the leak rate of the first specified gas and a relative percentage of the first specified gas in the air.

18. The leak detection method as claimed in claim 17, further comprising:
supplying the chamber with a second specified gas, and
evacuating the chamber to reach a pressure value higher than a base pressure.

19. The leak detection method as claimed in claim 17, further comprising:
disposing at least one object on an outer wall of the chamber and enabling fluid communication between an inside space of the at least one object and an inside space of the chamber.

20. The leak detection method as claimed in claim 17, further comprising:
disposing at least one object on an inner wall of the chamber and enabling fluid communication between an inside space of the at least one object and an outside of the chamber.
